(19) United States
(12) Patent Application Publication
(10) Pub. No.: US 2023/0377158 A1
(43) Pub. Date: Nov. 23, 2023

(54) IMAGE SEGMENTATION METHOD, APPARATUS, DEVICE, AND MEDIUM

(71) Applicant: HANGZHOU TUYA INFORMATION TECHNOLOGY CO., LTD., Hangzhou, Zhejiang (CN)

(72) Inventor: Jing HUA, Hangzhou (CN)

(73) Assignee: HANGZHOU TUYA INFORMATION TECHNOLOGY CO., LTD., Hangzhou, Zhejiang (CN)

(21) Appl. No.: 17/913,560

(22) PCT Filed: Dec. 30, 2020
(86) PCT No.: PCT/CN2020/141617

§ 371 Date: Sep. 22, 2022

(30) Foreign Application Priority Data
Apr. 22, 2020 (CN) 202010321730.7

(51) Int. Cl. G06T 7/11; G06T 7/136; G06T 7/155; G06T 5/30; G06T 5/00

(52) U.S. Cl. CPC G06T 7/11; G06T 7/136; G06T 7/155; G06T 5/30; G06T 5/003; G06T 2207/20028; G06T 2207/10024; G06T 2207/20041

(57) ABSTRACT

An image segmentation method, apparatus, device, and a medium that includes: performing a first segmentation on a target grayscale image to obtain a first sub-image set, where the target image is a grayscale image of a target color image; determining, using a grayscale histogram of each first sub-image in the first sub-image set, corresponding target grayscale data, including a mean, maximum, and minimum grayscale value; determining, using the target grayscale data, whether the first sub-image satisfies a preset segmentation condition; if so, performing a second segmentation on the first sub-image to obtain a second sub-image set; performing, using an OTSU maximum inter-class variance method, binarization processing respectively on each second sub-image in the second sub-image set and each first sub-image not subjected to the second segmentation, to obtain a corresponding first binarized image; and performing, using the first binarized image, watershed segmentation to obtain a segmented image.

### TECHNICAL FIELD

The present application relates to the technical field of image processing, in particular to an image segmentation method, apparatus and device, and a medium.

### BACKGROUND

Image segmentation refers to a technique and process for dividing an image into regions having various characteristics and extracting a target of interest therefrom. It is a very important step during image processing and detection analysis. In the image segmentation, target missing has always been a difficult point.

In the prior art, an OTSU maximum inter-class variance method is usually employed against the problem of target missing. However, for a complex background image with noise interference, nonuniform illumination, large variation in background grayscale and others, it is often impossible to take into account the actual condition of each region in the image by using a single global threshold obtained by the OTSU algorithm, leading to target missing. As a result, it is difficult to perform effective image segmentation.

### SUMMARY

The embodiments of the present application provide an image segmentation method, apparatus, device, and a medium, whereby the target missing during image segmentation can be avoided, thereby improving the effectiveness of image segmentation.

In one of the embodiments of the present application, an image segmentation method is provided. The image segmentation method comprises:

performing a first segmentation on a target grayscale image to obtain a corresponding first sub-image set, wherein the target grayscale image is a grayscale image corresponding to a target color image;

determining, by using a grayscale histogram corresponding to each first sub-image in the first sub-image set, target grayscale data corresponding to the first sub-image, wherein the target grayscale data comprises a mean grayscale value, a maximum grayscale value, and a minimum grayscale value;

determining, by using the target grayscale data, whether the corresponding first sub-image satisfies a preset segmentation condition;

if the first sub-image satisfies the preset segmentation condition, performing a second segmentation on the first sub-image to obtain a corresponding second sub-image set; if the first sub-image does not satisfy the preset segmentation condition, performing no segmentation on the first sub-image;

performing, by using an OTSU maximum inter-class variance method, binarization processing respectively on each second sub-image in the second sub-image set and each first sub-image not subjected to the second segmentation, to obtain a first binarized image corresponding to the target grayscale image; and

performing, by using the first binarized image, watershed segmentation on the target color image to obtain a corresponding segmented image.

Optionally, before performing the first segmentation on the target grayscale image to obtain the corresponding first sub-image set, the method further comprises:

converting an acquired target color image into a grayscale image; and

performing filtering processing on the converted grayscale image to obtain a corresponding filtered image.

Optionally, after performing the filtering processing on the converted grayscale image to obtain the corresponding filtered image, the method further comprises:

performing sharpening enhancement processing on the filtered image to obtain the corresponding target grayscale image.

Optionally, performing the filtering processing on the converted grayscale image to obtain the corresponding filtered image comprises:

performing bilateral filtering on the converted grayscale image to obtain the filtered image.

Optionally, performing, by using the first binarized image, the watershed segmentation on the target color image to obtain the corresponding segmented image comprises:

performing distance transformation on the first binarized image to obtain a distance-transformed image;

performing normalization processing on the distance-transformed image to obtain a normalized image;

performing, by using the OTSU maximum inter-class variance method, binarization processing on the normalized image to obtain a second binarized image; and

determining the second binarized image as a first tagged image, and performing, by using the first tagged image, the watershed segmentation on the target color image to obtain the corresponding segmented image.

Optionally, before performing the distance transformation on the first binarized image to obtain the distance-transformed image, the method further comprises:

performing morphological opening operation processing on the first binarized image to obtain the first binarized image subjected to the morphological opening operation processing.

Optionally, performing the morphological opening operation processing on the first binarized image to obtain the first binarized image subjected to the morphological opening operation processing comprises:

performing erosion processing on the first binarized image, and determining the first binarized image, subjected to the erosion processing, as a second tagged image;

determining the first binarized image, prior to the erosion processing, as a mask image; and

performing continuous expansion processing on the second tagged image until the second tagged image approximates the mask image, to obtain the first binarized image subjected to the morphological opening operation processing.

In one of the embodiments of the present application, an image segmentation apparatus is further provided. The image segmentation apparatus comprises:

a first image segmentation module configured to perform a first segmentation on a target grayscale image to obtain a corresponding first sub-image set, wherein the target grayscale image is a grayscale image corresponding to a target color image;

a grayscale data determination module configured to determine, by using a grayscale histogram corresponding to each first sub-image in the first sub-image set, target grayscale data corresponding to the first sub-image, wherein the target grayscale data comprises a mean grayscale value, a maximum grayscale value, and a minimum grayscale value;

a segmentation condition determination module configured to determine, by using the target grayscale data, whether the corresponding first sub-image satisfies a preset segmentation condition;

a second image segmentation module configured to perform, if the first sub-image satisfies the preset segmentation condition, a second segmentation on the first sub-image to obtain a corresponding second sub-image set, and perform, if the segmentation condition determination module determines that the first sub-image does not satisfy the preset segmentation condition, no segmentation on the first sub-image;

an image binarization module configured to perform, by using an OTSU maximum inter-class variance method, binarization processing respectively on each second sub-image in the second sub-image set and each first sub-image not subjected to the second segmentation, to obtain a first binarized image corresponding to the target grayscale image; and

a watershed segmentation module configured to perform, by using the first binarized image, watershed segmentation on the target color image to obtain a corresponding segmented image.

In one of the embodiments of the present application, an image segmentation device is further provided. The image segmentation device comprises a processor and a memory, wherein

the memory is configured to store a computer program; and

the processor is configured to execute the computer program to implement the image segmentation method previously defined.

In one of the embodiments of the present application, a computer-readable storage medium is further provided. The computer-readable storage medium is configured to store a computer program, wherein the computer program, when executed by a processor, implements the image segmentation method previously defined.

It can be seen that, in the embodiments of the present application, a first segmentation is first performed on a target grayscale image to obtain a corresponding first sub-image set, wherein the target grayscale image is a grayscale image corresponding to a target color image; then, target grayscale data corresponding to the first sub-image is determined by using a grayscale histogram corresponding to each first sub-image in the first sub-image set, wherein the target grayscale data comprises a mean grayscale value, a maximum grayscale value, and a minimum grayscale value; next, whether the corresponding first sub-image satisfies a preset segmentation condition is determined by using the target grayscale data; if the first sub-image satisfies the preset segmentation condition, a second segmentation is performed on the first sub-image to obtain a corresponding second sub-image set; if the first sub-image does not satisfy the preset segmentation condition, no segmentation is performed on the first sub-image; binarization processing is performed, by using an OTSU maximum inter-class variance method, respectively on each second sub-image in the second sub-image set and each first sub-image not subjected to the second segmentation, to obtain a first binarized image corresponding to the target grayscale image; and finally, watershed segmentation is performed, by using the first binarized image, on the target color image to obtain a corresponding segmented image. In this way, the mean grayscale value, the maximum grayscale value and the minimum grayscale value of the grayscale histogram corresponding to each first sub-image obtained by the first segmentation are determined respectively; whether the first sub-image satisfies the preset segmentation condition is determined by using the mean grayscale value, maximum grayscale value and minimum grayscale value corresponding to each first sub-image; the second segmentation is performed on each first sub-image that satisfies the preset segmentation condition; and then, each sub-image is binarized by using the OTSU algorithm to obtain the corresponding binarized image for image segmentation. Therefore, the problem that the actual condition of each region in the image cannot be taken into account by using the single global threshold obtained by the OTSU algorithm is solved, and target missing during image segmentation can be avoided, such that the effectiveness of image segmentation is improved.

### BRIEF DESCRIPTION OF THE DRAWINGS

For a clearer description of the technical solutions in the embodiments of the present application or in the prior art, the following briefly introduction to the accompanying drawings required to be used in the description of the embodiments or prior art. Obviously, the accompanying drawings in the following description show merely the embodiments of the present application, and a person of ordinary skills in the art can still derive other drawings from the provided accompanying drawings without creative effort.

FIG. 1 is a flow chart of an image segmentation method according to the present application;

FIG. 2 is a flow chart of an adaptive partial dynamic threshold segmentation algorithm according to the present application;

FIG. 3 is a flow chart of a specific image segmentation method according to the present application;

FIG. 4 is a flow chart of a specific image segmentation method according to the present application;

FIG. 5 is a schematic structural diagram of an image segmentation apparatus according to the present application;

FIG. 6 is a structural diagram of an image segmentation device according to the present application; and

FIG. 7 is a structural diagram of an electronic terminal according to the present application.

### DETAILED DESCRIPTION OF EMBODIMENTS

The technical solutions in the embodiments of the present application will be clearly and completely described below in conjunction with the accompanying drawings in the embodiments of the present application. Obviously, the described embodiments are merely some rather than all of the embodiments of the present application. On the basis of the embodiments in the present application, all other embodiments obtained by a person of ordinary skills in the art without creative effort shall be construed as falling within the scope of the present application.

In the prior art, an OTSU maximum inter-class variance method is usually employed against the problem of target missing. However, for a complex background image with noise interference, nonuniform illumination, large variation in background grayscale and others, it is often impossible to take into account the actual condition of each region in the image by using a single global threshold obtained by the OTSU algorithm, leading to target missing. As a result, it is difficult to perform effective image segmentation. For this purpose, the present application provides an image segmentation solution, which can avoid target missing during image segmentation, such that the effectiveness of image segmentation is improved.

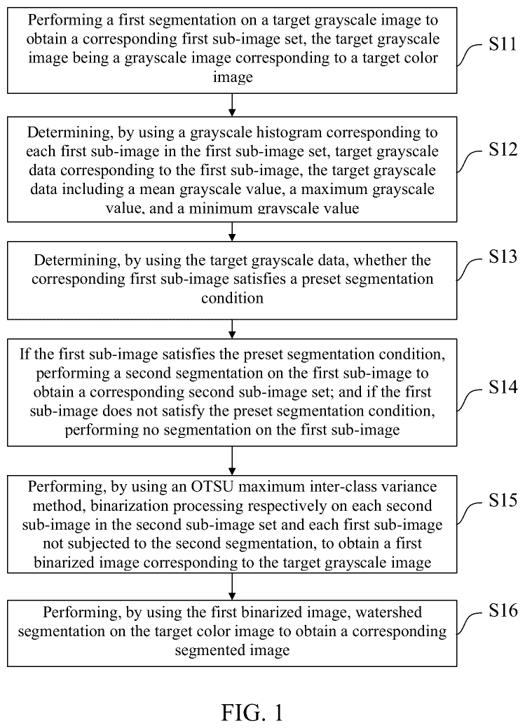

Referring to FIG. 1, an embodiment of the present application discloses an image segmentation method, which comprises the following steps.

In step S11, a first segmentation is performed on a target grayscale image to obtain a corresponding first sub-image set. The target grayscale image is a grayscale image corresponding to a target color image.

In a specific implementation, in this embodiment of the present application, the first segmentation may be performed on the target grayscale image, to obtain the corresponding first sub-image set. The first sub-images in the first sub-image set have equal size.

That is, in this embodiment of the present application, the first segmentation may be performed on the target grayscale image to obtain the first sub-image set having a first preset number of first sub-images that have equal size.

In step S12, by using a grayscale histogram corresponding to each first sub-image in the first sub-image set, target grayscale data corresponding to the first sub-image is determined. The target grayscale data comprises a mean grayscale value, a maximum grayscale value, and a minimum grayscale value.

That is, in this embodiment, the greyscale histogram of each first sub-image may be analyzed and calculated to obtain the corresponding mean grayscale value, maximum grayscale value and minimum grayscale value of the grayscale histogram of each sub-image.

In step S13, whether the corresponding first sub-image satisfies a preset segmentation condition is determined by using the target grayscale data.

In a specific implementation, in this embodiment of the present application, whether a first or second difference value corresponding to the first sub-image is smaller than a preset threshold is determined; if the first or second difference value is smaller than the preset threshold, it is determined that the first sub-image satisfies the preset segmentation condition; and if the first or second difference value is greater than or equal to the preset threshold, it is determined that the first sub-image does not satisfy the preset segmentation condition. The first difference value is a difference value between the mean grayscale value and the maximum grayscale value, and the second difference value is a difference value between the mean grayscale value and the minimum grayscale value.

In step S14, if the first sub-image satisfies the preset segmentation condition, a second segmentation is performed on the first sub-image to obtain a corresponding second sub-image set; and if the first sub-image does not satisfy the preset segmentation condition, no segmentation is performed on the first sub-image.

In step S15, binarization processing is performed, by using an OTSU maximum inter-class variance method, respectively on each second sub-image in the second sub-image set and each first sub-image not subjected to the second segmentation, to obtain a first binarized image corresponding to the target grayscale image. In a specific implementation, in this embodiment, after the binarization processing is performed, by using the OTSU maximum inter-class variance method, respectively on each second sub-image in the second sub-image set and each first sub-image not subjected to the second segmentation, the obtained binarized images corresponding to the second and first sub-images are spliced to obtain a first binarized image corresponding to the target grayscale image. That is, the first binarized image is a binarized image obtained by splicing the binarized images corresponding to the second and first sub-images.

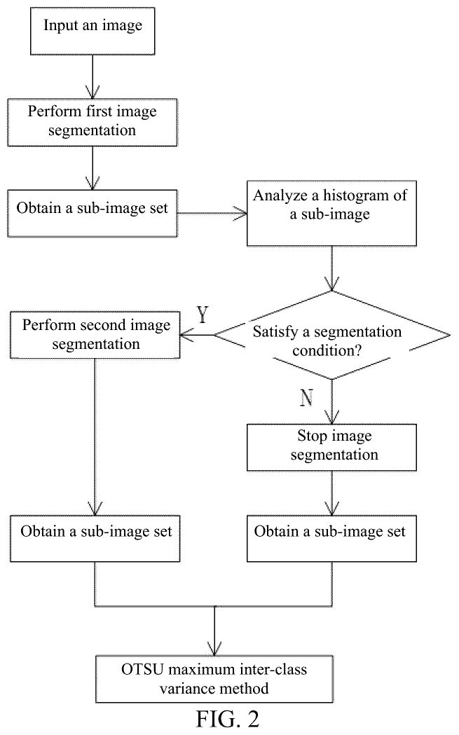

That is, the embodiment of the present application provides an adaptive partial dynamic segmentation algorithm, which may specifically include the following steps. Firstly, a first segmentation is performed on a target grayscale image to obtain a first sub-image set a₁, a₂, a₃, . . . aₙ, in which the first sub-images have equal size, and n represents the number of the first sub-images in the first sub-image set. Then, the grayscale histogram of each first sub-image is analyzed, and the mean grayscale value μ₁, maximum grayscale value g₁ and minimum grayscale value g₂ of the first sub-image are calculated. When the scale of a target in the image greatly differs from the scale of the background and the mean grayscale of the image is close to the maximum grayscale or the minimum grayscale, that is, when |μ₁−g₁| or |μ₁−g₂| is less than a threshold, a segmentation condition is satisfied, and in other cases, it is deemed that the segmentation condition is not satisfied. If a first sub-image does not satisfy the segmentation condition, a subsequent segmentation is stopped; and if the first sub-image satisfies the segmentation condition, a second segmentation is performed. The first sub-image satisfying the segmentation condition is segmented into four second sub-images having equal size, and then, all the sub-images obtained by segmentation are processed by using the OTSU maximum inter-class variance method to finally obtain the binarized image. This algorithm solves the problem that it is difficult to effectively segment a complex background image by means of a global threshold, and improves the effectiveness in the segmentation of the complex background image. For example, referring to FIG. 2, it is a flow chart of an adaptive partial dynamic threshold segmentation algorithm according to an embodiment of the present application.

In step S16, watershed segmentation is performed, by using the first binarized image, on the target color image to obtain a corresponding segmented image.

In a specific implementation, the first binarized image may be determined as a tagged image, and then, the watershed segmentation is performed on the target color image to obtain the corresponding segmented image.

It can be seen that, in the embodiments of the present application, a first segmentation is first performed on a target grayscale image to obtain a corresponding first sub-image set, wherein the target grayscale image is a grayscale image corresponding to a target color image; then, target grayscale data corresponding to the first sub-image is determined by using a grayscale histogram corresponding to each first sub-image in the first sub-image set, wherein the target grayscale data comprises a mean grayscale value, a maximum grayscale value, and a minimum grayscale value; next, whether the corresponding first sub-image satisfies a preset segmentation condition is determined by using the target grayscale data; if the first sub-image satisfies the preset segmentation condition, a second segmentation is performed on the first sub-image to obtain a corresponding second sub-image set; if the first sub-image does not satisfy the preset segmentation condition, no segmentation is performed on the first sub-image; binarization processing is performed, by using an OTSU maximum inter-class variance method, respectively on each second sub-image in the second sub-image set and each first sub-image not subjected to the second segmentation, to obtain a first binarized image corresponding to the target grayscale image; and finally, watershed segmentation is performed, by using the first binarized image, on the target color image to obtain a corresponding segmented image. In this way, the mean grayscale value, the maximum grayscale value and the minimum grayscale value of the grayscale histogram corresponding to each first sub-image obtained by the first segmentation are determined respectively; whether the first sub-image satisfies the preset segmentation condition is determined by using the mean grayscale value, maximum grayscale value and minimum grayscale value corresponding to each first sub-image; the second segmentation is performed on each first sub-image that satisfies the preset segmentation condition; and then, each sub-image is binarized by using the OTSU algorithm to obtain the corresponding binarized image for image segmentation. Therefore, the problem that the actual condition of each region in the image cannot be taken into account by using the single global threshold obtained by the OTSU algorithm is solved, and target missing during image segmentation can be avoided, such that the effectiveness of image segmentation is improved.

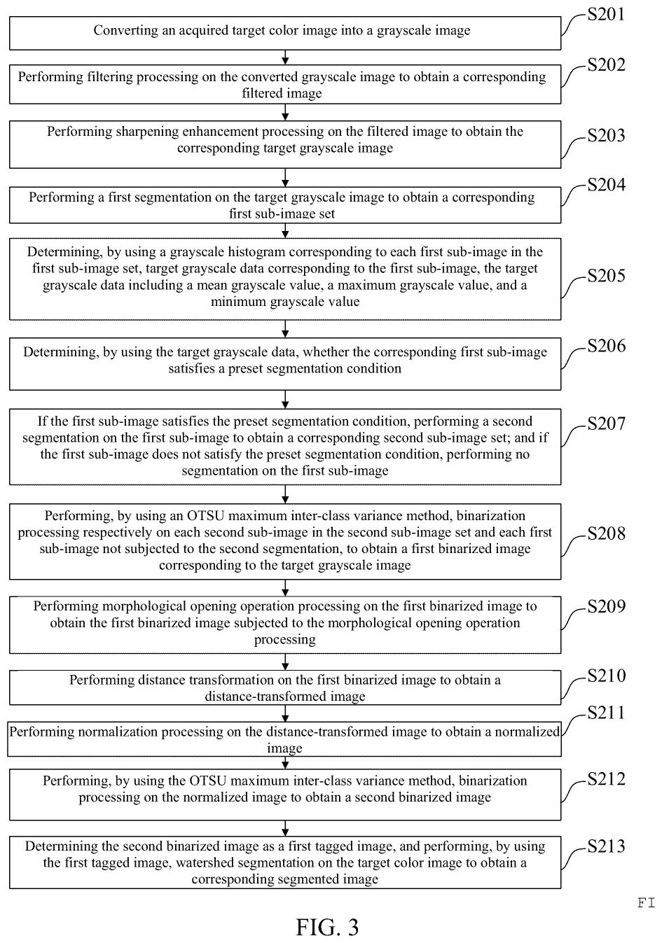

Referring to FIG. 3, an embodiment of the present application discloses a specific image segmentation method, which comprises the following steps.

In step S201, an acquired target color image is converted into a grayscale image.

In step S202, filtering processing is performed on the converted grayscale image to obtain a corresponding filtered image.

In a specific implementation, bilateral filtering may be performed on the converted grayscale image to obtain the filtered image.

It should be noted that the bilateral filtering not only can significantly eliminate noises, and but also can smoothen fine structures.

In step S203, sharpening enhancement processing is performed on the filtered image to obtain the corresponding target grayscale image.

In a specific implementation, in this embodiment, Laplace sharpening processing may be performed on the filtered image to obtain the sharpening-enhanced image.

It should be noted that image sharpening is a processing method for image enhancement, and it can make an image clearer and more detailed. In this embodiment, a Laplace operator is used for sharpening, with an applied template as follows:

$$W = ( \begin{matrix}- 1 & - 1 & - 1 \\ - 1 & 8 & - 1 \\ - 1 & - 1 & - 1\end{matrix} ) .$$

In step S204, a first segmentation is performed on a target grayscale image to obtain a corresponding first sub-image set. The target grayscale image is a grayscale image corresponding to a target color image.

In step S205, target grayscale data corresponding to the first sub-image is determined by using a grayscale histogram corresponding to each first sub-image in the first sub-image set. The target grayscale data comprises a mean grayscale value, a maximum grayscale value, and a minimum grayscale value.

In step S206, whether the corresponding first sub-image satisfies a preset segmentation condition is determined by using the target grayscale data.

In step S207, if the first sub-image satisfies the preset segmentation condition, a second segmentation is performed on the first sub-image to obtain a corresponding second sub-image set; and if the first sub-image does not satisfy the preset segmentation condition, no segmentation is performed on the first sub-image.

In step S208, binarization processing is performed, by using an OTSU maximum inter-class variance method, respectively on each second sub-image in the second sub-image set and each first sub-image not subjected to the second segmentation, to obtain a first binarized image corresponding to the target grayscale image.

For the specific processes of steps S204 to S208 described above, a reference can be made to the corresponding content disclosed in the foregoing embodiments, the details of which will not be repeated here anymore.

In step S209, morphological opening operation processing is performed on the first binarized image to obtain the first binarized image subjected to the morphological opening operation processing.

In a specific implementation, erosion processing is performed on the first binarized image, and the first binarized image subjected to the erosion processing is determined as a second tagged image; the first binarized image prior to the erosion processing is determined as a mask image; and continuous expansion processing is performed on the second tagged image until the second tagged image approximates the mask image, to obtain the first binarized image subjected to the morphological opening operation processing. With the morphological opening operation, it is conducive to removing tiny details and massive noises in the image.

In step S210, distance transformation is performed on the first binarized image to obtain a distance-transformed image.

That is, in this embodiment, the distance transformation may be performed on the first binarized image that is subjected to the opening operation. The result of the distance transformation is a piece of grayscale image similar to the target grayscale image, but with a grayscale value only appearing in a foreground region, and moreover, pixels farther away from a background edge have larger grayscale values.

In a specific implementation, a distance transformation formula in this embodiment is specifically as follows:

G(x,y)=255×(S(x,y)−Min)/(Max−Min),

in which S(x,y) represents a set composed of the shortest distance from each interior point in a connected domain in the first binarized image to a non-interior point set; Mtn represents the minimum value in the set S(x, y); Max represents the maximum value in the set S(x,y); G(x,y), represents a grayscale value corresponding to each interior pixel point in the connected domain after the distance transformation; (x,y) represents the coordinates of a pixel point; and in this embodiment, a distance from each interior point in the connected domain to the non-interior point set is calculated by using the Euclidean distance. Assuming a set A={(i, j)} for the coordinates of a pixel point at the edge of the connected domain and a set B={(t, s( )){}} for an interior pixel point of the connected domain, the formula for calculating the Euclidean distance is:

D[(i,j),(t,s)]=\sqrt{(i−t)²+(f−s)²}.

It should be noted that, in each connected domain, a center pixel point is the farthest from all zero pixel points on a boundary, and also has the largest grayscale value, such that a bright streak will be formed in the center of the connected domain, the final binary image will be converted into a grayscale image, and the grayscale value of each pixel point is a corresponding distance value.

Moreover, since the grayscale value of each point in the grayscale image is 255 at maximum and 0 at minimum, the value of S(Max−Min)in the above distance transformation formula may be large, for example 255, which leads to the value G(x,y) after transformation is small; and the coefficient 255 in 255×(S(x,y)−Min) is used to prevent the obtained value of G (x, y) from being too small, thereby guaranteeing that the value G (x, y) is greater than 1.

In step S211, normalization processing is performed on the distance-transformed image to obtain a normalized image.

In a specific implementation, after the distance transformation in this embodiment, a normalization operation may be performed to convert an original data range after the distance transformation to the range of [0,1]. A normalization formula is as follows:

$${G ( x , y )}_{norm} = \frac{G ( x , y ) - {G ( x , y )}_{min}}{G ( x , y ) {( x , y )}_{{min}_{max}}} ,$$

in which G(x,y)ₙₒᵣₘ represents data obtained after the normalization, G(x,y) represents original data before the normalization, and G(x,y)ₘₐₓ and G (x, y)ₘᵢₙ represent the maximum value and the minimum value of the original data set, respectively.

In step S212, binarization processing is performed, by using the OTSU maximum inter-class variance method, on the normalized image to obtain a second binarized image.

That is, the second binarized image is a binarized image that is obtained by performing the binarization processing on the normalized image by using the OTSU maximum inter-class variance method.

In step S213, the second binarized image is determined as a first tagged image, and the watershed segmentation is performed on the target color image by using the first tagged image to obtain the corresponding segmented image.

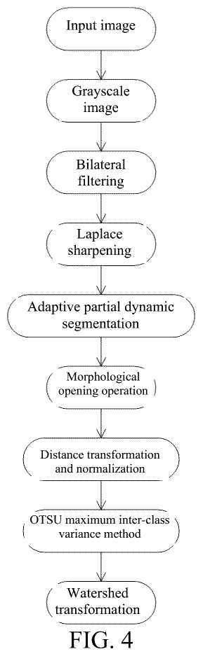

For example, referring to FIG. 4, an embodiment of the present application discloses a flow chart of a specific image segmentation method.

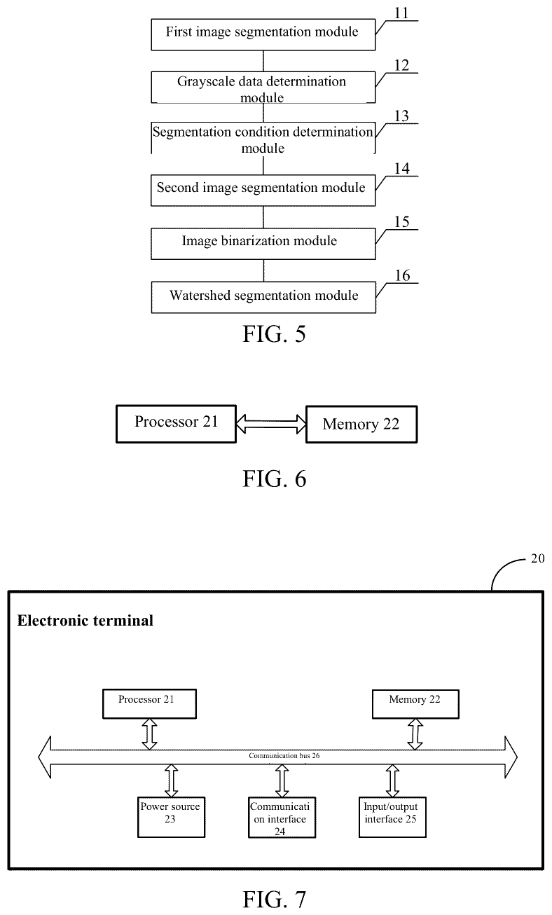

Referring to FIG. 5, an embodiment of the present application discloses an image segmentation apparatus, which comprises:

a first image segmentation module 11 configured to perform a first segmentation on a target grayscale image to obtain a corresponding first sub-image set, wherein the target grayscale image is a grayscale image corresponding to a target color image;

a grayscale data determination module 12 configured to determine, by using a grayscale histogram corresponding to each first sub-image in the first sub-image set, target grayscale data corresponding to the first sub-image, wherein the target grayscale data comprises a mean grayscale value, a maximum grayscale value, and a minimum grayscale value;

a segmentation condition determination module 13 configured to determine, by using the target grayscale data, whether the corresponding first sub-image satisfies a preset segmentation condition;

a second image segmentation module 14 configured to perform, if the segmentation condition determination module determines that the first sub-image satisfies the preset segmentation condition, a second segmentation on the first sub-image to obtain a corresponding second sub-image set, and perform, if the segmentation condition determination module determines that the first sub-image does not satisfy the preset segmentation condition, no segmentation on the first sub-image;

an image binarization module 15 configured to perform, by using an OTSU maximum inter-class variance method, binarization processing respectively on each second sub-image in the second sub-image set and each first sub-image not subjected to the second segmentation, to obtain a first binarized image corresponding to the target grayscale image; and

a watershed segmentation module 16 configured to perform, by using the first binarized image, watershed segmentation on the target color image to obtain a corresponding segmented image.

It can be seen that, in the embodiments of the present application, a first segmentation is first performed on a target grayscale image to obtain a corresponding first sub-image set, wherein the target grayscale image is a grayscale image corresponding to a target color image; then, target grayscale data corresponding to the first sub-image is determined by using a grayscale histogram corresponding to each first sub-image in the first sub-image set, wherein the target grayscale data comprises a mean grayscale value, a maximum grayscale value, and a minimum grayscale value; next, whether the corresponding first sub-image satisfies a preset segmentation condition is determined by using the target grayscale data; if the first sub-image satisfies the preset segmentation condition, a second segmentation is performed on the first sub-image to obtain a corresponding second sub-image set; if the first sub-image does not satisfy the preset segmentation condition, no segmentation is performed on the first sub-image; binarization processing is performed, by using an OTSU maximum inter-class variance method, respectively on each second sub-image in the second sub-image set and each first sub-image not subjected to the second segmentation, to obtain a first binarized image corresponding to the target grayscale image; and finally, watershed segmentation is performed, by using the first binarized image, on the target color image to obtain a corresponding segmented image. In this way, the mean grayscale value, the maximum grayscale value and the minimum grayscale value of the grayscale histogram corresponding to each first sub-image obtained by the first segmentation are determined respectively; whether the first sub-image satisfies the preset segmentation condition is determined by using the mean grayscale value, maximum grayscale value and minimum grayscale value corresponding to each first sub-image; the second segmentation is performed on each first sub-image that satisfies the preset segmentation condition; and then, each sub-image is binarized by using the OTSU algorithm to obtain the corresponding binarized image for image segmentation. Therefore, the problem that the actual condition of each region in the image cannot be taken into account by using the single global threshold obtained by the OTSU algorithm is solved, and target missing during image segmentation can be avoided, such that the effectiveness of image segmentation is improved.

The image segmentation apparatus further comprises an image grayscale processing module configured to convert an acquired target color image into a grayscale image.

The image segmentation apparatus further comprises an image filtering processing module configured to perform filtering processing on the converted grayscale image to obtain a corresponding filtered image. In a specific implementation, the image filtering processing apparatus is specifically configured to perform bilateral filtering on the converted grayscale image to obtain the filtered image.

The image segmentation apparatus further comprises an image enhancement processing module configured to perform sharpening enhancement processing on the filtered image to obtain the corresponding target grayscale image.

The watershed segmentation module 16 may specifically include:
a distance transformation sub-module configured to perform distance transformation on the first binarized image to obtain a distance-transformed image;

a normalization processing sub-module configured to perform normalization processing on the distance-transformed image to obtain a normalized image;

a binarization processing sub-module configured to perform, by using the OTSU maximum inter-class variance method, binarization processing on the normalized image to obtain a second binarized image; and

an image segmentation sub-module configured to determine the second binarized image as a first tagged image, and to perform, by using the first tagged image, watershed segmentation on the target color image to obtain a corresponding segmented image.

The image segmentation apparatus further comprises an opening operation processing module configured to perform morphological opening operation processing on the first binarized image to obtain the first binarized image subjected to the morphological opening operation processing.

In a specific implementation, the opening operation processing module is specifically configured to perform erosion processing on the first binarized image, and determine the first binarized image, subjected to the erosion processing, as a second tagged image; to determine the first binarized image, prior to the erosion processing, as a mask image; and to perform continuous expansion processing on the second tagged image until the second tagged image approximates the mask image, to obtain the first binarized image subjected to the morphological opening operation processing.

Referring to FIG. 6, it shows an image segmentation device according to an embodiment of the present application. The image segmentation device comprises a processor 21 and a memory 22. The memory 22 is configured to store a computer program; and the processor 21 is configured to execute the computer program to implement the following steps:

performing a first segmentation on a target grayscale image to obtain a corresponding first sub-image set, wherein the target grayscale image is a grayscale image corresponding to a target color image; determining, by using a grayscale histogram corresponding to each first sub-image in the first sub-image set, target grayscale data corresponding to the first sub-image, wherein the target grayscale data comprises a mean grayscale value, a maximum grayscale value, and a minimum grayscale value; determining, by using the target grayscale data, whether the corresponding first sub-image satisfies a preset segmentation condition; if the first sub-image satisfies the preset segmentation condition, performing a second segmentation on the first sub-image to obtain a corresponding second sub-image set; if the first sub-image does not satisfy the preset segmentation condition, performing no segmentation on the first sub-image; performing, by using an OTSU maximum inter-class variance method, binarization processing respectively on each second sub-image in the second sub-image set and each first sub-image not subjected to the second segmentation, to obtain a first binarized image corresponding to the target grayscale image; and performing, by using the first binarized image, watershed segmentation on the target color image to obtain a corresponding segmented image.

It can be seen that, in the embodiments of the present application, a first segmentation is first performed on a target grayscale image to obtain a corresponding first sub-image set, wherein the target grayscale image is a grayscale image corresponding to a target color image; then, target grayscale data corresponding to the first sub-image is determined by using a grayscale histogram corresponding to each first sub-image in the first sub-image set, wherein the target grayscale data comprises a mean grayscale value, a maximum grayscale value, and a minimum grayscale value; next, whether the corresponding first sub-image satisfies a preset segmentation condition is determined by using the target grayscale data; if the first sub-image satisfies the preset segmentation condition, a second segmentation is performed on the first sub-image to obtain a corresponding second sub-image set; if the first sub-image does not satisfy the preset segmentation condition, no segmentation is performed on the first sub-image; binarization processing is performed, by using an OTSU maximum inter-class variance method, respectively on each second sub-image in the second sub-image set and each first sub-image not subjected to the second segmentation, to obtain a first binarized image corresponding to the target grayscale image; and finally, watershed segmentation is performed, by using the first binarized image, on the target color image to obtain a corresponding segmented image. In this way, the mean grayscale value, the maximum grayscale value and the minimum grayscale value of the grayscale histogram corresponding to each first sub-image obtained by the first segmentation are determined respectively; whether the first sub-image satisfies the preset segmentation condition is determined by using the mean grayscale value, maximum grayscale value and minimum grayscale value corresponding to each first sub-image; the second segmentation is performed on each first sub-image that satisfies the preset segmentation condition; and then, each sub-image is binarized by using the OTSU algorithm to obtain the corresponding binarized image for image segmentation. Therefore, the problem that the actual condition of each region in the image cannot be taken into account by using the single global threshold obtained by the OTSU algorithm is solved, and target missing during image segmentation can be avoided, such that the effectiveness of image segmentation is improved.

In this embodiment, when the processor 21 executes a computer sub-program stored in the memory 22, the following steps may be specifically implemented: converting an acquired target color image into a grayscale image; and performing filtering processing on the converted grayscale image to obtain a corresponding filtered image.

In this embodiment, when the processor 21 executes the computer sub-program stored in the memory 22, the following step may be specifically implemented: performing sharpening enhancement processing on the filtered image to obtain the corresponding target grayscale image.

In this embodiment, when the processor 21 executes the computer sub-program stored in the memory 22, the following step may be specifically implemented: performing bilateral filtering on the converted grayscale image to obtain the filtered image.

In this embodiment, when the processor 21 executes the computer sub-program stored in the memory 22, the following steps may be specifically implemented: performing distance transformation on the first binarized image to obtain a distance-transformed image; performing normalization processing on the distance-transformed image to obtain a normalized image; performing binarization processing on the normalized image by using the OTSU maximum inter-class variance method to obtain a second binarized image; and determining the second binarized image as a first tagged image, and performing watershed segmentation on the target color image by using the first tagged image to obtain a corresponding segmentation image.

In this embodiment, when the processor 21 executes the computer sub-program stored in the memory 22, the following step may be specifically implemented: performing morphological opening operation processing on the first binarized image to obtain the first binarized image subjected to the morphological opening operation processing.

In this embodiment, when the processor 21 executes the computer sub-program stored in the memory 22, the following steps may be specifically implemented: performing erosion processing on the first binarized image, and determining the first binarized image, subjected to the erosion processing, as a second tagged image; determining the first binarized image, prior to the erosion processing, as a mask image; and performing continuous expansion processing on the second tagged image until the second tagged image approximates the mask image, to obtain the first binarized image subjected to the morphological opening operation processing.

Moreover, the memory 22, as a resource storage carrier, may be a read-only memory, a random memory, a magnetic disk, an optical disk, etc., and the storage mode thereof may include transient storage or permanent storage.

Referring to FIG. 7, an embodiment of the present application discloses an electronic terminal 20, which comprises the processor 21 and the memory 22, which are disclosed in the foregoing embodiments. For the specific steps that can be executed by the processor 21, a reference can be made to the corresponding content disclosed in the foregoing embodiments, so the details of which will not be repeated here anymore.

Further, the electronic terminal 20 in this embodiment may further specifically include a power source 23, a communication interface 24, an input/output interface 25 and a communication bus 26. The power source 23 is configured to supply a working voltage to various hardware devices on the terminal 20. The communication interface 24 is capable of establishing a data transmission channel between the terminal 20 and an external device, and the communication interface complies with any communication protocol that is applicable to the technical solution of the present application, which is not specifically defined here. The input/output interface 25 is configured to acquire input data from outside and output data to the outside, and the specific type of the interface may be selected according to a specific application, which is not specifically defined here.

Further, an embodiment of the present application further discloses a computer-readable storage medium, which is configured to store a computer program, wherein the computer program, when executed by the processor, implements the following steps:

Performing a first segmentation on a target grayscale image to obtain a corresponding first sub-image set, wherein the target grayscale image is a grayscale image corresponding to a target color image; determining, by using a grayscale histogram corresponding to each first sub-image in the first sub-image set, target grayscale data corresponding to the first sub-image, wherein the target grayscale data comprises a mean grayscale value, a maximum grayscale value, and a minimum grayscale value; determining, by using the target grayscale data, whether the corresponding first sub-image satisfies a preset segmentation condition; if the first sub-image satisfies the preset segmentation condition, performing a second segmentation on the first sub-image to obtain a corresponding second sub-image set; if the first sub-image does not satisfy the preset segmentation condition, performing no segmentation on the first sub-image; performing, by using an OTSU maximum inter-class variance method, binarization processing respectively on each second sub-image in the second sub-image set and each first sub-image not subjected to the second segmentation, to obtain a first binarized image corresponding to the target grayscale image; and performing, by using the first binarized image, watershed segmentation on the target color image to obtain a corresponding segmented image.

It can be seen that, in the embodiments of the present application, a first segmentation is first performed on a target grayscale image to obtain a corresponding first sub-image set, wherein the target grayscale image is a grayscale image corresponding to a target color image; then, target grayscale data corresponding to the first sub-image is determined by using a grayscale histogram corresponding to each first sub-image in the first sub-image set, wherein the target grayscale data comprises a mean grayscale value, a maximum grayscale value, and a minimum grayscale value; next, whether the corresponding first sub-image satisfies a preset segmentation condition is determined by using the target grayscale data; if the first sub-image satisfies the preset segmentation condition, a second segmentation is performed on the first sub-image to obtain a corresponding second sub-image set; if the first sub-image does not satisfy the preset segmentation condition, no segmentation is performed on the first sub-image; binarization processing is performed, by using an OTSU maximum inter-class variance method, respectively on each second sub-image in the second sub-image set and each first sub-image not subjected to the second segmentation, to obtain a first binarized image corresponding to the target grayscale image; and finally, watershed segmentation is performed, by using the first binarized image, on the target color image to obtain a corresponding segmented image. In this way, the mean grayscale value, the maximum grayscale value and the minimum grayscale value of the grayscale histogram corresponding to each first sub-image obtained by the first segmentation are determined respectively; whether the first sub-image satisfies the preset segmentation condition is determined by using the mean grayscale value, maximum grayscale value and minimum grayscale value corresponding to each first sub-image; the second segmentation is performed on each first sub-image that satisfies the preset segmentation condition; and then, each sub-image is binarized by using the OTSU algorithm to obtain the corresponding binarized image for image segmentation. Therefore, the problem that the actual condition of each region in the image cannot be taken into account by using the single global threshold obtained by the OTSU algorithm is solved, and target missing during image segmentation can be avoided, such that the effectiveness of image segmentation is improved.

In this embodiment, when a computer sub-program stored in the computer-readable storage medium is executed by the processor, the following steps may be specifically implemented: converting an acquired target color image into a grayscale image; and performing filtering processing on the converted grayscale image to obtain a corresponding filtered image.

In this embodiment, when the computer sub-program stored in the computer-readable storage medium is executed by the processor, the following step may be specifically implemented: performing sharpening enhancement processing on the filtered image to obtain the corresponding target grayscale image.

In this embodiment, when the computer sub-program stored in the computer-readable storage medium is executed by the processor, the following step may be specifically implemented: performing bilateral filtering on the converted grayscale image to obtain the filtered image.

In this embodiment, when the computer sub-program stored in the computer-readable storage medium is executed by the processor, the following steps may be specifically implemented: performing distance transformation on the first binarized image to obtain a distance-transformed image; performing normalization processing on the distance-transformed image to obtain a normalized image; performing binarization processing on the normalized image by using the OTSU maximum inter-class variance method to obtain a second binarized image; and determining the second binarized image as a first tagged image, and performing watershed segmentation on the target color image by using the first tagged image to obtain a corresponding segmentation image.

In this embodiment, when the computer sub-program stored in the computer-readable storage medium is executed by the processor, the following step may be specifically implemented: performing morphological opening operation processing on the first binarized image to obtain the first binarized image subjected to the morphological opening operation processing.

In this embodiment, when the computer sub-program stored in the computer-readable storage medium is executed by the processor, the following steps may be specifically implemented: performing erosion processing on the first binarized image, and determining the first binarized image, subjected to the erosion processing, as a second tagged image; determining the first binarized image, prior to the erosion processing, as a mask image; and performing continuous expansion processing on the second tagged image until the second tagged image approximates the mask image, to obtain the first binarized image subjected to the morphological opening operation processing.

The embodiments in the specification are described progressively, with each embodiment focusing on the description of its differences from other embodiments. The embodiments may be referred to each other for the same or similar parts. For the apparatus disclosed in the embodiments, since it corresponds to the method disclosed in the embodiments, the description is relatively simple, and the description of the method section may be referred to for the relevant parts.

The steps of the methods or algorithms described in conjunction with the embodiments disclosed herein may be implemented directly by using hardware, software modules executed by a processor, or a combination of the two. The software modules may be placed in a random-access memory (RAM), an internal memory, a read-only memory (ROM), an electric programmable ROM, an electric erasable programmable ROM, a register, a hard disk, a removable magnetic disk, a CD-ROM, or storage mediums in any other forms as commonly known in the technical field.

The image segmentation method, apparatus and device and the medium according to the present application have been described in detail above. Specific examples are used herein to explain the principles and embodiments of the present application. The embodiments are described above merely for the purpose of helping understand the method and the core concept of the present application. Meanwhile, for a person of ordinary skills in the art, there will be changes in the specific implementation and application scope based on the concept of the present application. In summary, the content of the specification should not be understood as a limit to the present application.

1-10. (canceled)

11. An image segmentation method comprising:
performing a first segmentation on a target grayscale image to obtain a corresponding first sub-image set, wherein the target grayscale image is a grayscale image corresponding to a target color image;
determining, by using a grayscale histogram corresponding to each first sub-image in the first sub-image set, target grayscale data corresponding to the first sub-image, wherein the target grayscale data comprises a mean grayscale value, a maximum grayscale value, and a minimum grayscale value;
determining, by using the target grayscale data, whether the corresponding first sub-image satisfies a preset segmentation condition;
when the first sub-image satisfies the preset segmentation condition, performing a second segmentation on the first sub-image to obtain a corresponding second sub-image set;
when the first sub-image does not satisfy the preset segmentation condition, performing no segmentation on the first sub-image;
performing, by using an OTSU maximum inter-class variance method, binarization processing respectively on each second sub-image in the second sub-image set and each first sub-image not subjected to the second segmentation, to obtain a first binarized image corresponding to the target grayscale image; and
performing, by using the first binarized image, watershed segmentation on the target color image to obtain a corresponding segmented image.

12. The image segmentation method according to claim 11, wherein before performing the first segmentation on the target grayscale image to obtain the corresponding first sub-image set, the method further comprises:
converting an acquired target color image into a grayscale image; and
performing filtering processing on the converted grayscale image to obtain a corresponding filtered image.

13. The image segmentation method according to claim 12, wherein after performing the filtering processing on the converted grayscale image to obtain the corresponding filtered image, the method further comprises:
performing sharpening enhancement processing on the filtered image to obtain the corresponding target grayscale image.

14. The image segmentation method according to claim 12, wherein performing the filtering processing on the converted grayscale image to obtain the corresponding filtered image comprises:
performing bilateral filtering on the converted grayscale image to obtain the filtered image.

15. The image segmentation method according to claim 11, wherein performing, by using the first binarized image, the watershed segmentation on the target color image to obtain the corresponding segmented image comprises:
performing distance transformation on the first binarized image to obtain a distance-transformed image;
performing normalization processing on the distance-transformed image to obtain a normalized image;
performing, by using the OTSU maximum inter-class variance method, binarization processing on the normalized image to obtain a second binarized image; and
determining the second binarized image as a first tagged image, and performing, by using the first tagged image, the watershed segmentation on the target color image to obtain the corresponding segmented image.

16. The image segmentation method according to claim 15, wherein before performing the distance transformation on the first binarized image to obtain the distance-transformed image, the method further comprises:
performing morphological opening operation processing on the first binarized image to obtain the first binarized image subjected to the morphological opening operation processing.

17. The image segmentation method according to claim 16, wherein performing the morphological opening operation processing on the first binarized image to obtain the first binarized image subjected to the morphological opening operation processing comprises:
performing erosion processing on the first binarized image, and determining the first binarized image subjected to the erosion processing as a second tagged image;
determining the first binarized image, prior to the erosion processing, as a mask image; and
performing continuous expansion processing on the second tagged image until the second tagged image approximates the mask image, to obtain the first binarized image subjected to the morphological opening operation processing.

18. An image segmentation apparatus, comprising
a first image segmentation module configured to perform a first segmentation on a target grayscale image to obtain a corresponding first sub-image set, wherein the target grayscale image is a grayscale image corresponding to a target color image;
a grayscale data determination module configured to determine, by using a grayscale histogram corresponding to each first sub-image in the first sub-image set, target grayscale data corresponding to the first sub-image, wherein the target grayscale data comprises a mean grayscale value, a maximum grayscale value, and a minimum grayscale value;
a segmentation condition determination module configured to determine, by using the target grayscale data, whether the corresponding first sub-image satisfies a preset segmentation condition;
a second image segmentation module configured to perform, when the first sub-image satisfies the preset segmentation condition, a second segmentation on the first sub-image to obtain a corresponding second sub-image set, and perform, when the segmentation condition determination module determines that the first sub-image does not satisfy the preset segmentation condition, no segmentation on the first sub-image;
an image binarization module configured to perform, by using an OTSU maximum inter-class variance method, binarization processing respectively on each second sub-image in the second sub-image set and each first sub-image not subjected to the second segmentation, to obtain a first binarized image corresponding to the target grayscale image; and
a watershed segmentation module configured to perform, by using the first binarized image, watershed segmentation on the target color image to obtain a corresponding segmented image.

19. An image segmentation device, comprising a processor and a memory, wherein
the memory is configured to store a computer program; and
the processor is configured to execute the computer program to implement the image segmentation method according to claim 11.

20. A computer-readable storage medium, configured to store a computer program, wherein the computer program, when executed by a processor, implements the image segmentation method according to claim 11.
